(19) United States
(12) Patent Application Publication
(10) Pub. No.: US 2024/0334337 A1
(43) Pub. Date: Oct. 3, 2024

(54) METHOD FOR SWITCHING BANDWIDTH PARTS, AND TERMINAL AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/743,433

(22) Filed: Jun. 14, 2024

Related U.S. Application Data
(63) Continuation of application No. PCT/CN2021/140182, filed on Dec. 21, 2021.

(51) Int. Cl. H04W 52/02

(52) U.S. Cl. CPC H04W 52/0248; H04W 52/0229

(57) ABSTRACT

Provided is a method for switching bandwidth parts (BWPs). The method includes: determining, by a terminal, a target BWP in an activated serving cell as an activated BWP in the activated serving cell in response to switching from a first receiving state to a second receiving state, wherein the first receiving state and the second receiving state have different transmission parameters, the transmission parameter comprising at least one of a receiver, a waveform, a modulation mode, an encoding mode, or a multiple access mode.

### CROSS-REFERENCE TO RELATED APPLICATION

This application is a continuation application of International Application No. PCT/CN2021/140182, filed on Dec. 21, 2021, the entire contents of which are incorporated herein by reference.

### TECHNICAL FIELD

The present disclosure relates to the technical field of communications, and in particular, relates to a method and an apparatus for switching bandwidth parts (BWPs), and a device and a storage medium.

### BACKGROUND

In the evolution of the 5^{th} generation (5G) mobile communication systems, higher requirements on power saving are put forward for a user equipment (UE) in a connected state.

### SUMMARY

Embodiments of the present disclosure provide a method and an apparatus for switching bandwidth parts (BWPs), and a device and a storage medium, and provide a method for a terminal to determine an activated BWP in the case that the terminal switches from a first receiving state to a second receiving state. The technical solutions are as follows:

According to some embodiments of the present disclosure, a method for switching BWPs is provided.

The method includes: determining, by a terminal, a target BWP in an activated serving cell as an activated BWP in the activated serving cell in response to switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, a method for switching BWPs is provided.

The method includes: configuring, by a network device, a configuration parameter of a first BWP for a terminal, wherein the first BWP is an activated BWP in an activated serving cell determined by the terminal in response to switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, an apparatus for switching BWPs is provided.

The apparatus includes: a determining module, configured to determine a target BWP in an activated serving cell as an activated BWP in the activated serving cell in response switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, an apparatus for switching BWPs is provided.

The apparatus includes: a configuring module, configured to configure a configuration parameter of a first BWP for a terminal, wherein the first BWP is an activated BWP in an activated serving cell determined by the terminal in response to switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, a terminal is provided.

The terminal includes a processor, wherein the processor is operable to determine a target BWP in an activated serving cell as an activated BWP in the activated serving cell in response to switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, a network device is provided.

The network device includes a processor, wherein the processor is operable to configure a configuration parameter of a first BWP for a terminal, wherein the first BWP is an activated BWP in an activated serving cell determined by the terminal in response to switching from a first receiving state to a second receiving state, wherein the first receiving state and the second receiving state have different transmission parameters, the transmission parameter including at least one of a receiver, a waveform, a modulation mode, an encoding mode, or a multiple access mode.

According to some embodiments of the present disclosure, a non-transitory computer-readable storage medium is provided. The computer-readable storage medium stores a computer program. The computer program, when run by a processor, causes the processor to perform the method for switching BWPs as described above.

According to some embodiments of the present disclosure, a chip is provided. The chip includes a programmable logic circuit and/or program instructions. The chip, when running, is caused to perform the method for switching BWPs as described above.

According to some embodiments of the present disclosure, a computer program product or a computer program is provided. The computer program product or the computer program includes computer instructions. The computer instructions are stored in a computer-readable storage medium, wherein when read from the computer-readable storage medium and executed by a processor, cause the processor to perform the method for switching BWPs as described above.

### BRIEF DESCRIPTION OF THE DRAWINGS

For clearer descriptions of the technical solutions in the embodiments of the present disclosure, the accompanying drawings required for describing the embodiments are briefly described below. Apparently, the accompanying drawings in the following description show merely some embodiments of the present disclosure, and a person of ordinary skill in the art may still derive other drawings from these accompanying drawings without creative efforts.

FIG. 1 is a schematic diagram of a terminal according to some embodiments of the present disclosure;

FIG. 2 is a schematic diagram of a mobile communication system according to some embodiments of the present disclosure;

FIG. 3 is a flowchart of a method for switching BWPs according to some embodiments of the present disclosure;

FIG. 4 is a flowchart of a method for switching BWPs according to some embodiments of the present disclosure;

FIG. 5 is a schematic diagram of a terminal according to some embodiments of the present disclosure;

FIG. 6 is a flowchart of a method for switching BWPs according to some embodiments of the present disclosure;

FIG. 7 is a schematic diagram of a method for switching BWPs according to some embodiments of the present disclosure;

FIG. 8 is a flowchart of a method for switching BWPs according to some embodiments of the present disclosure;

FIG. 9 is a flowchart of a method for switching BWPs according to some embodiments of the present disclosure;

FIG. 10 is a schematic diagram of a method for switching BWPs according to some embodiments of the present disclosure;

FIG. 11 is a schematic diagram of an apparatus for switching BWPs according to some embodiments of the present disclosure;

FIG. 12 is a schematic diagram of an apparatus for switching BWPs according to some embodiments of the present disclosure; and

FIG. 13 is a schematic structural diagram of a communication device according to some embodiments of the present disclosure.

### DETAILED DESCRIPTION

For clearer descriptions of the objects, technical solutions, and advantages of the present disclosure, embodiments of the present disclosure are further described in detail below with reference to the accompanying drawings.

Prior to detailed description of the technical solutions according to the present disclosure, relevant knowledge involved in the present disclosure is first explained below:

Currently, with the pursuit of speed, delay, high-speed mobility, and energy efficiency, and the diversity and complexity of services in future life, the 3GPP has begun to develop a 5^{th} generation (5G) communication system. The main application scenarios of 5G include: enhanced mobile broadband (cMBB), ultra-reliable & low-latency communication (URLLC), and massive machine type of communication (mMTC).

A new radio (NR) may also be deployed independently, and for reduction of radio signalings, quick recovery of wireless connections, and quick recovery of data services in a 5G network environment, a new radio resource control (RRC) state, i.e., an RRC_INACTIVE state, is defined. This state is different from an RRC_IDLE state and an RRC_ACTIVE state.

RRC_IDLE: The mobility is cell selection and reselection based on a terminal, paging is initiated by the terminal, and a paging region is configured by the terminal. Neither a terminal access stratum (AS) context nor an RRC connection is present on a network device.

RRC_CONNECTED: An RRC connection is present, and a terminal AS context is present on both the network device and the terminal. The network device determines the location of the terminal at the granularity of cell, and the mobility is mobility controlled by the network device. Unicast data may be transmitted between the terminal and the network device.

RRC_INACTIVE: The mobility is cell selection and reselection based on the terminal, a connection is present between a core network (CN) and an NR, which may be abbreviated as a connection between CN-NR, a terminal AS context is present on a network device, paging is initiated by a radio access network (RAN), a paging region based on the RAN is managed by the RAN, and the network device determines the location of the terminal at the granularity of RAN-based paging region.

### 5G NR Bandwidth Part (BWP) Switching:

In order to provide a higher data transmission rate and improve user experience, 5G NR further increases the system bandwidth on the basis of 4G. In 5G NR, a maximum bandwidth supported by a single carrier is 100 MHz for frequency bands below 6 GHZ; and a the maximum bandwidth supported by a single carrier is 400 MHz for frequency bands above 6 GHz. For a large carrier bandwidth, such as 100 MHz, the bandwidth that the terminal needs to use is often very limited, and in the case that the terminal is allowed to carry out detection and measurement on the whole bandwidth all the time, power consumption of the terminal is extremely high, which is not favorable to power saving. Therefore, BWP is introduced into 5G NR, that is, a part of contiguous bandwidth is extracted from the large overall carrier bandwidth for the terminal to carry out data transmission and reception. The terminal only needs to perform relevant operations in the bandwidth part configured by the network device, such that the effect of saving energy of the terminal is achieved.

As stipulated in the 5G NR protocol standards, for each serving cell of the terminal, the network device may configure one or more BWPs in the serving cell for the terminal over an RRC message, wherein a maximum configurable number of BWPs is 4. At each moment, the terminal may have only one activated downlink BWP (DL BWP) and one activated uplink BWP (UL BWP) in the serving cell, and the terminal may only perform data transmission and reception on the activated BWPs.

The terminal may have a need to adjust BWPs in consideration of the diversity of the terminal services and the differences between different service features. For example, in the case that the terminal experiences heavy traffic, the terminal expects to acquire a high-rate service, and needs to use a BWP with a large bandwidth for data transmission; and in the case that the terminal experiences light traffic, the terminal may use a BWP with a small bandwidth for data transmission. The terminal may change the activated BWP of the terminal in the corresponding serving cell by switching BWPs.

Illustratively, four methods for switching BWPs supported in the related art are as follows:
1. BWP switching is performed based on a physical downlink control channel (PDCCH).

The BWP switching is controlled by a network device.

Illustratively, the network device transmits a PDCCH to the terminal and informs the terminal of a target BWP for switching.
2. BWP switching is performed based on RRC configuration or RRC reconfiguration.

The BWP switching is controlled by a network device.

Illustratively, for each serving cell of the terminal, the network device configures the switched BWP on the corresponding serving cell for the terminal over an RRC configuration message or an RRC reconfiguration message. The switched BWP includes a first active downlink BWP identifier (first active downlink BWP-Id) and/or a first active uplink BWP identifier (first active uplink BWP-Id).

In the case that a first active downlink BWP identifier and/or a first active uplink BWP identifier are configured on a primary secondary cell (PSCell), after RRC reconfiguration is performed, the activated BWP of the terminal on the PSCell is the first active downlink BWP identifier and/or the first active uplink BWP identifier.

In the case that a first active downlink BWP identifier and/or a first active uplink BWP identifier is configured in a secondary cell (SCell), after the terminal activates the SCell, the activated BWP of the terminal in the SCell is the first active downlink BWP identifier and/or the first active uplink BWP identifier.
3. BWP switching is performed based on timeout of a timer.

BWP switching is performed in an implicit manner.

Illustratively, the network device configures a BWP-inactivity timer for the terminal. For each serving cell:
in the case that the terminal has a default BWP configured in the serving cell and the currently activated DL BWP of the terminal is a BWP other than the default BWP and a dormant BWP; or
in the case that the terminal is not configured with a default BWP in the serving cell and the currently activated DL BWP of the terminal is a BWP other than an initial BWP and a dormant BWP;
then: in the case that the terminal receives, on the currently activated BWP, a PDCCH indicating uplink or downlink scheduling of the UE, or the terminal receives a PDCCH indicating uplink or downlink scheduling of the UE on the currently activated BWP, or the terminal sends uplink transmission over a configured grant (CG) resource, or the terminal receives downlink transmission over a semi-persistent scheduling (SPS) resource, the terminal starts or restarts the BWP-inactivity timer.

In the case of timeout of the BWP-inactivity timer, the BWP for the terminal is automatically switched to the default BWP or the initial BWP. The default BWP and the initial BWP are both determined by RRC configuration.
4. BWP switching is caused by random access initialization.

In an initialization process of a random access channel (RACH), in the case that the terminal does not configure a physical random access channel (PRACH) scenario on the currently activated UL BWP, the terminal automatically switches the UL BWP to an initial uplink BWP (initial UL BWP), and meanwhile switches the DL BWP to an initial downlink BWP (initial DL BWP).

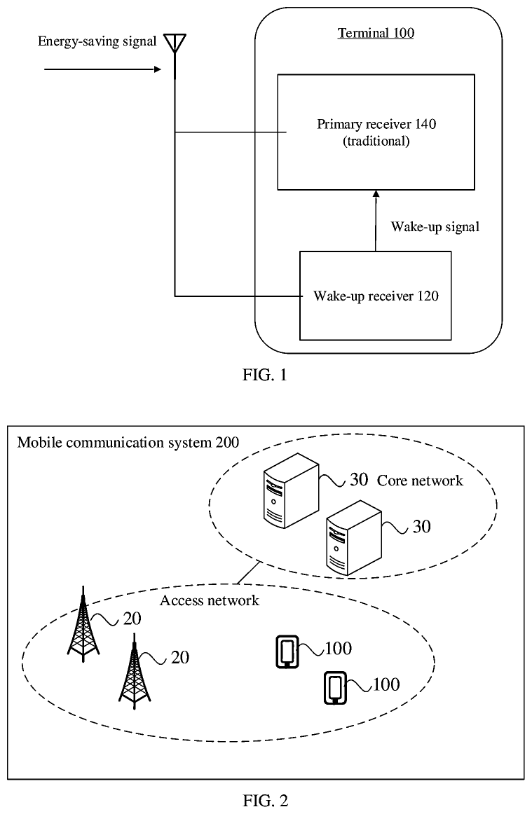

FIG. 1 shows a terminal 100 with a wake-up receiver according to some embodiments of the present disclosure. The terminal 100 includes: a wake-up receiver 120 and a primary receiver 140.

The wake-up receiver 120 is a zero-power receiver or a low-power receiver with power consumption lower than a predetermined condition. The wake-up receiver 120 receives an energy-saving signal and transmits a response signal of the energy-saving signal based on a first transmission parameter.

The primary receiver 140 is a traditional receiver. The primary receiver 140 receives and transmits control channels and other traditional communication signals based on a second transmission parameter.

In some embodiments, the wake-up receiver 120 is also referred to as a low-power-consumption receiver, a low-power receiver, a zero-power receiver, and other names that indicate that signal transmission and reception is performed at low power consumption. Under the same condition, for example, both for transmission of an energy-saving signal or a wake-up signal, the first transmission parameter has lower energy consumption than the second transmission parameter.

FIG. 2 shows a schematic diagram of a mobile communication system 200 according to some embodiments of the present disclosure. The mobile communication system 200 at least includes the following functional nodes:
a terminal 100: provided with both a wake-up receiver 120 and a primary receiver 140, as shown in FIG. 2;
a network device 20: providing a communication link for the terminal 100 and/or providing the terminal 100 with radio waves based on the radio wave energy harvested by the RF energy harvesting module, i.e., power supply; and
a core network (CN) device 30: configured to perform data processing and reception, and control and manage related services, mobility, user plane, control plane, gateway and other functions of the terminal 100.

In the related art, in order to avoid that the primary receiver is in an on state for a long time, an ultra-low power wake-up signal (LP-WUS) receiver is considered to be introduced to achieve energy saving of the terminal. However, in the receiving state corresponding to monitoring the LP-WUS, the terminal will not receive the scheduling of the network device, and the terminal will also not perform data transmission and reception, and at the moment, a BWP where the terminal is not operating is present.

Where the terminal monitors the LP-WUS, how to determine the activated bandwidth part of the terminal needs to be discussed in the case that the terminal switches from the receiving state corresponding to monitoring LP-WUS back to the receiving state corresponding to the primary receiver.

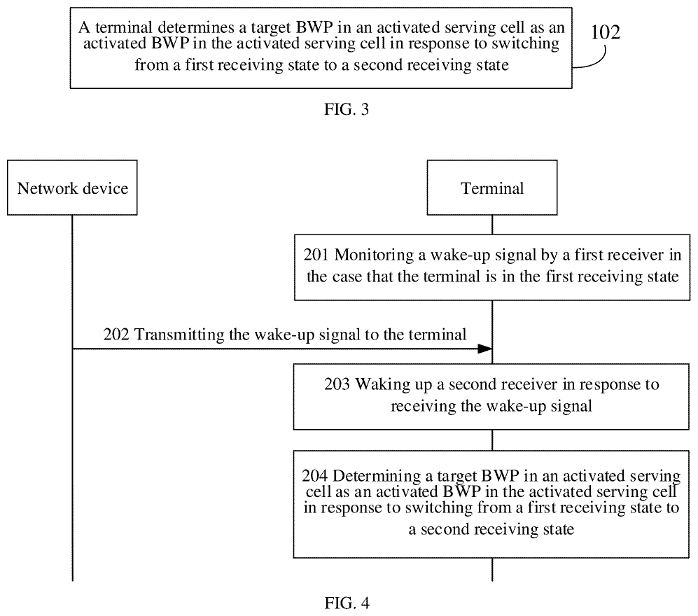

FIG. 3 shows a flowchart of a method for switching BWPs according to some embodiments of the present disclosure. The method is applicable to a terminal, and includes the following process.

In process 102, a terminal determines a target BWP in an activated serving cell as an activated BWP in the activated serving cell in response to switching from a first receiving state to a second receiving state.

Illustratively, the first receiving state and the second receiving state have different transmission parameters. The transmission parameter includes at least one of a receiver, a waveform, a modulation mode, an encoding mode, or a multiple access mode.

The receiver includes a wake-up receiver and a primary receiver.

Taking the terminal including the wake-up receiver and the primary receiver as an example, the first receiving state is a receiving state when the wake-up receiver is in an operating state and the primary receiver is in an off state or a deep sleep state. The first receiving state may also be referred to as a low-power receiving state or a wake-up receiving state. The second receiving state is a receiving state when the primary receiver is in an operating state, and the second receiving state may also be referred to as a normal receiving state.

Illustratively, taking the transmission parameter in the first receiving state being a first transmission parameter and the transmission parameter in the second receiving state being a second transmission parameter as an example, the first transmission parameter is a transmission parameter corresponding to the wake-up receiver or the low-power receiver; and the second transmission parameter is a transmission parameter corresponding to a traditional receiver, or a transmission parameter corresponding to a conventional receiver.

The modulation mode of the first transmission parameter includes any one of amplitude shift keying (ASK) modulation, frequency shift keying (FSK) modulation, or binary phase-shift keying (2Phase-Shift Keying, 2PSK) modulation. The modulation mode of the second transmission parameter includes any one of orthogonal frequency-division multiplexing (OFDM) modulation, quadrature phase-shift keying (QPSK) modulation, or quadrature amplitude modulation (QAM).

ASK is a digital modulation in which the amplitude of a carrier varies with a digital baseband signal. In the case that the digital baseband signal is binary, the modulation mode is binary amplitude shift keying (2ASK). 2ASK is also referred to as on-off keying (OOK), which controls on and off of a main track carrier by using a unipolar non-return-to-zero code sequence. In some embodiments, ASK further includes 4ASK, 8ASK, or the like, which is not limited in the embodiments of the present disclosure.

FSK is a digital modulation in which the frequency of a carrier varies with a digital baseband signal. In the case that the digital baseband signal is binary, the modulation mode is binary frequency shift keying (2FSK). 2FSK accomplishes information transmission by converting two different carrier signals into digital signals. The state of the transmitted information is represented by the change of the carrier frequency, and the frequency of a modulated carrier varies with the states of binary sequences 0 and 1. In some embodiments, FSK further includes 4FSK, 8FSK, or the like, which is not limited in the embodiments of the present disclosure.

PSK is a digital modulation in which the phase of a carrier varies with a digital baseband signal. 2PSK is the simplest form of phase shift keying, and conveys binary information over two carriers separated by 180° in initial phases, also known as BPSK. QPSK is quadrature phase-shift keying, and represents the input digital information using four different phase differences of carriers.

OFDM is a kind of multi-carrier modulation (MCM), and its main principle is to divide a channel into several orthogonal sub-channels, convert a high-speed data signal into parallel low-speed sub-data streams, and modulate the data streams onto each of the sub-channels for transmission. OFDM includes V-OFDM, W-OFDM, F-OFDM, MIMO-OFDM, multi-band-OFDM, or the like, which is not limited in the embodiments of the present disclosure.

QAM is a double-sideband modulation in which two mutually orthogonal co-frequency carriers are suppressed by two independent baseband digital signals, and two-way parallel digital information transmission is achieved by using the property that the modulated signals are orthogonal in frequency spectra in the same bandwidth. It is a modulation technology that combines a multi-system digital amplitude modulation (MASK) and a multi-system digital phase modulation (MPSK) together, such that the bandwidth is doubled.

The first transmission parameter adopts a simple low-order digital modulation mode, the second transmission parameter adopts a complex high-order orthogonal digital modulation mode, and thus the signal complexity of the first transmission parameter is lower than that of the second transmission parameter.

It should be noted that the examples of the modulation mode of the first transmission parameter and the modulation mode of the second transmission parameter in the above embodiments are only examples, and should not constitute any limitation on the present disclosure, and other existing or future defined modulation modes are not excluded from generating the first transmission parameter or the second transmission parameter.

The first transmission parameter and the second transmission parameter have different encoding modes. The encoding mode of the first transmission parameter includes any one of reverse non-return-to-zero encoding, Manchester encoding, unipolar return-to-zero encoding, differential biphase encoding, Miller encoding, or differential encoding. The encoding mode of the second transmission parameter includes any one of a reed-muller (RM) code, a tail biting CC (TBCC), a turbo code, an outer code, a low-density parity-check code (LDPC), or a polar code.

The first transmission parameter and the second transmission parameter have different multiple access modes. The multiple access mode of the first transmission parameter includes any one of frequency-division multiple access (FDMA), time-division multiple access (TDMA), or code-division multiple access (CDMA). The multiple access mode of the second transmission parameter includes any one of orthogonal frequency-division multiple access (OFDMA) or discrete Fourier transform-spread orthogonal frequency-division multiplexing (DFT-Spread OFDM, DFTS-OFDM).

It should be understood that the signal waveforms generated using different modulation modes are different. In the embodiments of the present disclosure, the first feedback signal and the second feedback signal have different modulation modes, and thus the waveforms of the first feedback signal and the second feedback signal are different.

In some embodiments, the terminal is in an RRC connected state.

For each serving cell of the terminal, the target BWP is a BWP in the corresponding activated serving cell. In the case that the serving cell is in an activated state, the activated serving cell has one activated BWP thereon, and the activated BWPs in different activated serving cells are different.

In some embodiments, the target BWP includes one of:
A first BWP configured by a network device

For example, the network device configures a first BWP for the terminal, and the terminal determines the first BWP as an activated BWP in an activated serving cell according to configuration information of the network device.

In some embodiments, the first BWP is a downlink BWP.
An initial activated BWP

Illustratively, the initial activated BWP is a first active BWP, including a first active downlink BWP identifier (first active downlink BWP-Id) and/or a first active uplink BWP identifier (first active uplink BWP-Id). In some embodiments, the initial activated BWP is configured for the terminal by the network device over high-level signaling.

For each serving cell of the terminal, the network device may configure an initial activated BWP in the serving cell over an RRC configuration or reconfiguration message.

For example, in the case that a first active downlink BWP identifier and/or a first active uplink BWP identifier is configured on a PSCell, upon RRC reconfiguration, the activated BWP of the terminal on the PSCell is the first active downlink BWP identifier and/or the first active uplink BWP identifier.

For example, in the case that a first active downlink BWP identifier and/or a first active uplink BWP identifier is configured on a SCell, upon activation of the SCell by the terminal, the activated BWP of the terminal on the SCell is the first active downlink BWP identifier and/or the first active uplink BWP identifier.
A second BWP activated by the terminal prior to entering the first receiving state

The terminal determines a second BWP on an activated serving cell as the activated BWP on the activated serving cell in response to switching from the first receiving state to the second receiving state, such that the terminal prior to and upon state switching use the same (activated) BWP, which is the second BWP.

Description is given hereinafter using the case where the first receiving state is a low-power receiving state and the second receiving state is a normal receiving state as an example. In the case that the target BWP is the first BWP, the terminal receives a configuration parameter of the first BWP configured by the network device, and upon switching from the low-power receiving state to the normal receiving state, the terminal determines, for each activated serving cell, a first BWP in the activated serving cell as the activated BWP. Each activated serving cell has a different first BWP.

In the case that the target BWP is an initial activated BWP, upon switching from the low-power receiving state to the normal receiving state, the terminal determines, for each activated serving cell, an initial activated BWP in the activated serving cell as the activated BWP. Each activated serving cell has a different initial activated BWP.

In the case that the target BWP is the second BWP, the terminal is in the normal receiving state prior to entering the low-power receiving state, and at the moment, the BWP activated by the terminal is the second BWP; and upon switching from the low-power receiving state to the normal receiving state, the terminal determines, for each activated serving cell, a second BWP in the activated serving cell as the activated BWP. Each activated serving cell has a different second BWP.

In summary, in the method for switching BWPs according to the embodiments of the present disclosure, the terminal determines a target BWP in an activated serving cell as an activated BWP corresponding to the serving cell in response to switching from the first receiving state to the second receiving state, such that the terminal is capable of determining the activated BWP in the activated serving cell upon state switching.

Taking the terminal including the wake-up receiver and the primary receiver as an example, state switching of the terminal from the first receiving state to the second receiving state is achieved by turning on and off the receiver. FIG. 4 shows a flowchart of a method for switching BWPs according to some embodiments of the present disclosure. The method includes the following processes.

In process 201, the terminal monitors a wake-up signal by a first receiver in the case that a terminal is in a first receiving state.

In this process, the first receiver of the terminal is in an operating state, a second receiver of the terminal is in an off state or a deep sleep state, the first receiver is a receiver operating in the first receiving state, and the second receiver is a receiver operating in the second receiving state.

Illustratively, the wake-up signal is configured to instruct the terminal to wake up the second receiver. In some embodiments, the wake-up signal is an ultra-low power wake-up signal (LP-WUS).

Description is given hereinafter using the case where the first receiver is the wake-up receiver and the second receiver is the primary receiver as an example. In the first receiving state, the terminal monitors the wake-up signal by a wake-up receiver, and the first receiving state may be referred to as a wake-up receiving state or a low-power receiving state.

In process 202, a network device transmits the wake-up signal to the terminal.

In this process, for details about the wake-up signal, reference is made to the description above, which are not described herein any further.

In process 203, the terminal wakes up the second receiver in response to receiving the wake-up signal.

In the case that the terminal is in the first receiving state, the terminal monitors the wake-up signal by the first receiver, and then wakes up the second receiver in response to receiving the wake-up signal from the network device.

The case where the first receiver is the wake-up receiver and the second receiver is the primary receiver is taken as an example. In response to receiving the wake-up signal from the network device, the terminal wakes up the primary receiver.

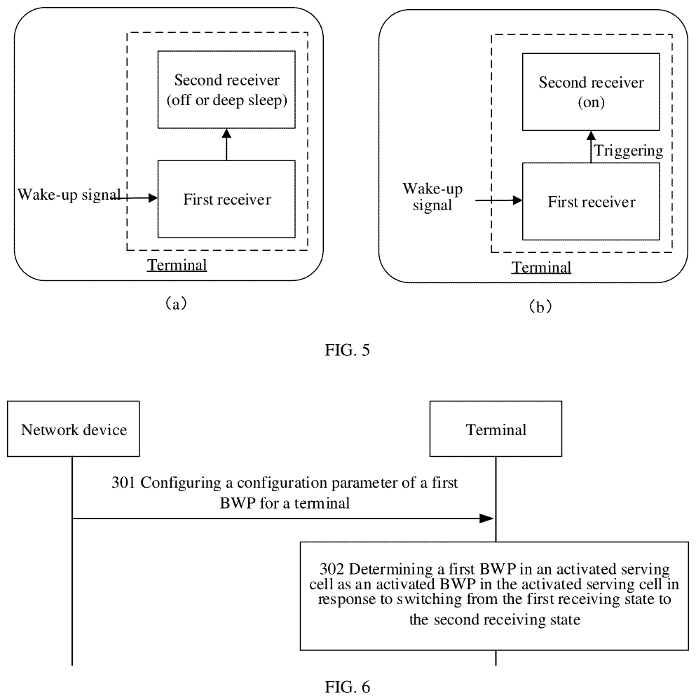

FIG. 5 shows a schematic diagram of a terminal according to some embodiments of the present disclosure. The terminal includes a first receiver and a second receiver, wherein the first receiver is configured to monitor a wake-up signal.

Referring to FIG. 5(a), the terminal is in a first receiving state, and monitors a wake-up signal by the first receiver. The first receiver is in an operating state, and the second receiver is in an off state or a deep sleep state. At the moment, the power consumption of the terminal in the first receiving state is low.

Referring to FIG. 5(b), the terminal monitors a wake-up signal by the first receiver, and the first receiver wakes up the second receiver. At the moment, the terminal wakes up the second receiver, and the second receiver is turned on to be in an operating state. At the moment, the terminal switches from the first receiving state to a second receiving state. As the second receiver is in the operating state, the power consumption of the terminal in the second receiving state is higher than that of the terminal in the first receiving state.

In some embodiments, the first receiver is a wake-up receiver and the second receiver is a primary receiver.

In process 204, the terminal determines a target BWP in an activated serving cell as an activated BWP in the activated serving cell in response to switching from the first receiving state to the second receiving state.

Illustratively, the first receiving state and the second receiving state have different transmission parameters. The transmission parameter includes at least one of a receiver, a waveform, a modulation mode, an encoding mode, or a multiple access mode.

In this process, for details about the transmission parameters of the first receiving state and the second receiving state, reference is made to the description above, which are not described herein any further.

Taking the terminal including the wake-up receiver and the primary receiver as an example, the first receiving state is a receiving state when the wake-up receiver is in an operating state and the primary receiver is in an off state or a deep sleep state, and the first receiving state may also be referred to as a low-power receiving state or a wake-up receiving state. The second receiving state is a receiving state when the primary receiver is in an operating state, and the second receiving state may also be referred to as a normal receiving state.

In some embodiments, the target BWP includes one of: a first BWP configured by the network device, an initial activated BWP, or a second BWP activated by the terminal prior to entering the first receiving state.

Illustratively, as process 204 is the same as process 102, for details about process 204, reference is made to process 102, which are not described herein any further.

Illustratively, in the embodiments according to the foregoing content, the processes at the terminal side may individually become embodiments of the method for switching BWPs that is applicable to the terminal, the processes at the network device side may individually become the method for switching BWPs that is applicable to the network device, and for specific explanation of the processes of the method for switching BWP, reference is made to the above content, which is not described herein any further.

In summary, the method for switching BWPs according to the embodiments of the present disclosure provides different states of the receivers during state switching of the terminal: in the case that the terminal is in the first receiving state, the terminal monitors the wake-up signal by the first receiver, at the moment, the first receiver is in an operating state, and the second receiver is in an off state or a deep sleep state; and the terminal wakes up the second receiver in response to receiving the wake-up signal, and at the moment, the second receiver is in an operating state.

According to the foregoing content, the target BWP includes one of: a first BWP configured by the network device; an initial activated BWP or a second BWP activated by the terminal prior to entering the first receiving state.

Based on different target BWPs, the embodiments of the present disclosure provide at least one or any one of the following three methods for switching BWPs:

### 1. The Target BWP is a First BWP Configured by the Network Device.

FIG. 6 shows a flowchart of a method for switching BWPs according to some embodiments of the present disclosure. The method includes the following processes.

In process 301, a network device configures a configuration parameter of a first BWP for a terminal.

Illustratively, the first BWP is an activated BWP in an activated serving cell determined by the terminal in the case that the terminal switches from a first receiving state to a second receiving state.

The first receiving state and the second receiving state have different transmission parameters. The transmission parameter includes at least one of a receiver, a waveform, a modulation mode, an encoding mode, or a multiple access mode. For details about the transmission parameters of the first receiving state and the second receiving state, reference is made to the description above, which are not described herein any further.

Illustratively, the configuration parameter of the first BWP includes, but is not limited to, at least one of: frequency domain location, or size and base numerology configuration of the BWP. The high-level signaling parameters corresponding to the size of the BWP are locationAndBandwidth; and the subcarrier spacing in the base numerology is represented by a parameter μ.

In some embodiments, the configuration parameter of the first BWP is configured over a system message or terminal-specific signaling.

Based on this, process 301 may be implemented as follows: The network device configures the configuration parameter of the first BWP for the terminal over a system message; or the network device configures the configuration parameter of the first BWP for the terminal over terminal-specific signaling.

The terminal-specific signaling optionally includes one of: RRC signaling, a medium access control-control element (MAC-CE), a physical downlink control channel (PDCCH), or a low-power wake-up (LPW) signal.

In process 302, the terminal determines a first BWP in an activated serving cell as an activated BWP in the activated serving cell in response to switching from the first receiving state to the second receiving state.

In this process, the first BWP indicates the activated BWP of the terminal in the activated serving cell in the case that the terminal switches from the first receiving state to the second receiving state.

As process 302 is similar to process 102, for details about process 302, reference is made to process 102, which are not described herein any further.

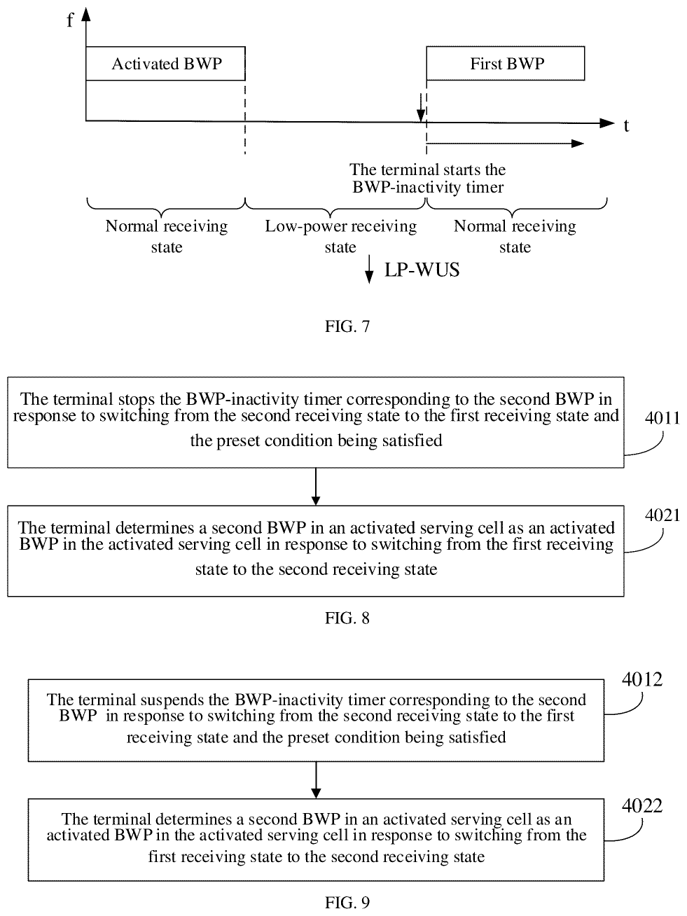

Taking the first receiving state being a low-power receiving state and the second receiving state being a normal receiving state as an example, FIG. 7 shows a schematic diagram of a method for switching BWPs according to some embodiments of the present disclosure.

Illustratively, in the case that the terminal in an RRC connected state switches from the low-power receiving state to the normal receiving state, the activated BWP of the terminal in each activated serving cell is determined as the first BWP. Each activated serving cell has a different first BWP.

In some embodiments, the first BWP is configured by the network device.

In some embodiments, the first BWP is a downlink BWP.

For each serving cell of the terminal, the first BWP is a BWP in the corresponding activated serving cell. Illustratively, in the case that a plurality of activated serving cells are present, the activated BWPs are different in different activated serving cells. In the case that a serving cell is in an activated state, a first BWP in the activated serving cell may be determined as an activated BWP, and the first BWPs are different in different activated serving cells.

The method for switching BWPs according to the embodiments of the present disclosure specifically includes the following processes.
(1) A terminal receives a configuration parameter of a first BWP configured by a network device.

Illustratively, a first BWP is configured for each serving cell, and the first initial BWP indicates the activated BWP of the terminal in the serving cell in the case that the terminal switches from a low-power receiving state to a normal receiving state. The serving cell includes a primary secondary cell and a secondary cell.

In some embodiments, the first BWP is configured for the terminal by the network device over a system message or terminal-specific signaling. The terminal-specific signaling optionally includes one of: an RRC signaling, a MAC-CE, a PDCCH, or an LPW.
(2) In the case that the terminal in an RRC connected state switches from the low-power receiving state to the normal receiving state, for each activated serving cell, an activated BWP of the terminal in the serving cell is the first BWP.

The terminal switches from the low-power receiving state to the normal receiving state by turning on or off the receiver. For example, the terminal monitors the LP-WUS by a low-power receiver, and in response to receiving the LP-WUS, the terminal wakes up the primary receiver and switches from a low-power receiving state to a normal receiving state.

Referring to FIG. 7, in a first normal receiving state, the terminal uses an activated BWP; and in a second normal receiving state, the terminal uses a first BWP, and in some embodiments, the two BWPs are the same or different.

In some embodiments, the BWP-inactivity timer according to the embodiments of the present disclosure starts or resumes operating in response to a preset condition being satisfied. The duration of the BWP-inactivity timer is configured by the network device. For example, the network device configures the duration of the BWP-inactivity timer over RRC signaling. The relevant contents of the BWP-inactivity timer and the preset condition will be described below.

In the case that the terminal performs data transmission and reception over a BWP, the terminal starts a BWP-inactivity timer corresponding to the BWP. In the case of the BWP-inactivity timer timeout, it is deemed that the terminal does not perform data transmission and reception on the BWP within the duration, and at the moment, the BWP for the terminal is switched to a default BWP or an initially configured BWP.

In summary, in the method for switching BWPs according to the embodiments of the present disclosure, in the case that the target BWP is the first BWP configured by the network device, the terminal determines the first BWP in the activated serving cell as the activated BWP in the serving cell, such that the BWP switching is more flexible. In some embodiments, the network device may configure the first BWP over a system message or terminal-specific signaling, such that the terminal can determine the activated BWP in the activated serving cell according to the configuration of the network device.

### 2. The Target BWP is an Initial Activated BWP.

The case where the first receiving state is a low-power receiving state and the second receiving state is a normal receiving state is taken as an example.

Illustratively, in the case that the terminal in an RRC connected state switches from the low-power receiving state to the normal receiving state, the activated BWP of the terminal in each activated serving cell is determined as an initial activated BWP.

Illustratively, the initial activated BWP is a first active BWP, including a first active downlink BWP and/or a first active uplink BWP. For example, the network device configures an initial activated BWP for the terminal over terminal-specific high-level signaling.

For each serving cell of the terminal, the initial activated BWP is a BWP in the corresponding serving cell. Illustratively, in the case that a plurality of activated serving cells are present, the activated BWPs are different in different activated serving cells.

The method for switching BWPs according to the embodiments of the present disclosure specifically includes the following processes.
(1) The terminal in an RRC connected state monitors an LP-WUS in a low-power receiving state.

For example, the terminal monitors the LP-WUS using a low-power receiver (e.g., an LP-WUS receiver). At the moment, the LP-WUS receiver is in an operating state, and a primary receiver (main radio) is in an off state or a deep sleep state.
(2) The terminal wakes up the primary receiver in response to receiving the LP-WUS.

At the moment, for each activated serving cell, the activated BWP of the terminal in the serving cell is determined as the initial activated BWP.

For details of the initial activated BWP, reference is made to the description above, which are not described herein any further.

In summary, in the method for switching BWPs according to the embodiments of the present disclosure, in the case that the target BWP is the initial activated BWP configured by the network device, the terminal determines the initial activated BWP in the activated serving cell as the activated BWP in the serving cell, such that the terminal determines the activated BWP based on the originally configured BWP without requiring the network device to reconfigure the activated BWP.

### 3. The Target BWP is a Second BWP Activated by the Terminal Prior to Entering the First Receiving State.

According to the above content, in the case that the terminal performs data transmission over a BWP, the terminal starts a BWP-inactivity timer corresponding to the BWP. In the case of the BWP-inactivity timer timeout, it is deemed that the terminal does not perform data transmission and reception on the BWP within the duration.

Illustratively, the BWP-inactivity timer is in a running state before the terminal is in the first receiving state. Taking the first receiving state being a low-power receiving state and the second receiving state being a normal receiving state as an example, before the terminal is in the low-power receiving state, it is deemed that the terminal is in the normal receiving state, and at the moment, the BWP-inactivity timer is in the running state.

In some embodiments, for the BWP-inactivity timer according to the embodiments of the present disclosure, the terminal controls the BWP-inactivity timer in the case that a preset condition is satisfied. For example, the terminal starts or resumes the operation of the BWP-inactivity timer in response to the preset condition being satisfied.

The preset condition includes: the network device configures a default downlink BWP for the terminal, and the second BWP is neither the default downlink BWP nor a dormant BWP; or the network device does not configure the default downlink BWP for the terminal, and the second BWP is neither an initial downlink BWP nor the dormant BWP.

In some embodiments, the terminal stops or suspends the BWP-inactivity timer in response to switching from the first receiving state to the second receiving state. Referring to FIGS. 8 and 9, according to different operations of the terminal, two different methods for switching BWPs are provided in the embodiments of the present disclosure, which are specifically described as follows.

FIG. 8 shows a flowchart of a method for switching BWPs according to some embodiments of the present disclosure. The method includes the following processes.

In process 4011, the terminal stops the BWP-inactivity timer corresponding to the second BWP in response to switching from the second receiving state to the first receiving state and the preset condition being satisfied.

In this process, for details about the preset condition, reference is made to the foregoing content, which are not described herein any further.

Taking the first receiving state being a low-power receiving state and the second receiving state being a normal receiving state as an example, in response to switching from the normal receiving state to the low-power receiving state and the second BWP satisfying the preset condition, the terminal stops the BWP-inactivity timer corresponding to the second BWP, and monitors the wake-up signal using a low-power receiver.

In process 4021, the terminal determines a second BWP in an activated serving cell as an activated BWP in the activated serving cell in response to switching from the first receiving state to the second receiving state.

In this process, the second BWP is a BWP activated by the terminal prior to entering the first receiving state.

The case where the first receiving state is a low-power receiving state and the second receiving state is a normal receiving state is taken as an example. The terminal, prior to entering the low-power receiving state, is in the normal receiving state, and the second BWP is a BWP activated by the terminal in the normal receiving state.

For each serving cell of the terminal, the second BWP is a BWP in the corresponding activated serving cell. Illustratively, in the case that a plurality of activated serving cells are present, the activated BWPs are different in different activated serving cells.

In some embodiments, process 4021 is implemented as follows: determining, by the terminal, a second BWP corresponding to each activated serving cell as an activated BWP corresponding to the activated serving cell in response to switching from the first receiving state to the second receiving state; and starting, by the terminal, the BWP-inactivity timer in response to the preset condition being satisfied.

In this process, starting the BWP-inactivity timer means that the terminal restarts the timing of the BWP-inactivity timer.

Illustratively, the preset condition may refer to the foregoing content, and are not described herein any further.

The case where the first receiving state is a low-power receiving state and the second receiving state is a normal receiving state is taken as an example. In response to switching from the normal receiving state to the low-power receiving state, the terminal stops the BWP-inactivity timer and monitors a wake-up signal using a low-power receiver.

Subsequently, in response to switching from the low-power receiving state to the normal receiving state, for each activated serving cell, the terminal determines a second BWP corresponding to the activated serving cell as an activated BWP corresponding to the activated serving cell; and the terminal restarts the BWP-inactivity timer in response to the preset condition being satisfied. The second BWP corresponding to the serving cell is the BWP activated by the terminal in the normal receiving state.

Illustratively, as process 4021 is similar to process 102, for details about process 4021, reference is made to process 102, which are not described herein any further.

FIG. 9 shows a flowchart of a method for switching BWPs according to some embodiments of the present disclosure. The method includes the following processes.

In process 4012, the terminal suspends the BWP-inactivity timer corresponding to the second BWP in response to switching from the second receiving state to the first receiving state and the preset condition being satisfied.

In this process, suspending the BWP-inactivity timer means that the terminal stops the timing of the BWP-inactivity timer in response to the second BWP satisfying the preset condition.

Taking the first receiving state being a low-power receiving state and the second receiving state being a normal receiving state as an example, in response to switching from the normal receiving state to the low-power receiving state, the terminal stops the timing of the BWP-inactivity timer and monitors the wake-up signal using a low-power receiver.

In process 4022, the terminal determines a second BWP in an activated serving cell as an activated BWP in the activated serving cell in response to switching from the first receiving state to the second receiving state.

In this process, the second BWP is a BWP activated by the terminal prior to entering the first receiving state.

The case where the first receiving state is a low-power receiving state and the second receiving state is a normal receiving state is taken as an example. The terminal, prior to entering the low-power receiving state, is in the normal receiving state, and the second BWP is a BWP activated by the terminal in the normal receiving state.

In some embodiments, process 4022 is implemented as follows: determining, by the terminal, a second BWP corresponding to each activated serving cell as an activated BWP corresponding to the activated serving cell in response to switching from the first receiving state to the second receiving state; and the terminal resumes the operation of the BWP-inactivity timer in response to the preset condition being satisfied.

In this process, resuming the operation of the BWP-inactivity timer means that the terminal resumes the timing of the BWP-inactivity timer.

Illustratively, for details about the preset condition, reference is made to the foregoing content, which are not described herein any further.

The case where the first receiving state is a low-power receiving state and the second receiving state is a normal receiving state is taken as an example. In response to switching from the normal receiving state to the low-power receiving state and the preset condition being satisfied, the terminal stops the timing of the BWP-inactivity timer and monitors a wake-up signal using a low-power receiver.

Subsequently, in response to switching from the low-power receiving state to the normal receiving state, for each activated serving cell, the terminal determines a second BWP corresponding to the activated serving cell as an activated BWP corresponding to the activated serving cell; and the terminal resumes the timing of the BWP-inactivity timer in response to the preset condition being satisfied. The second BWP corresponding to the serving cell is the BWP activated by the terminal in the normal receiving state.

Illustratively, as process 4022 is similar to process 102, for details about process 4022, reference is made to process 102, which are not described herein any further.

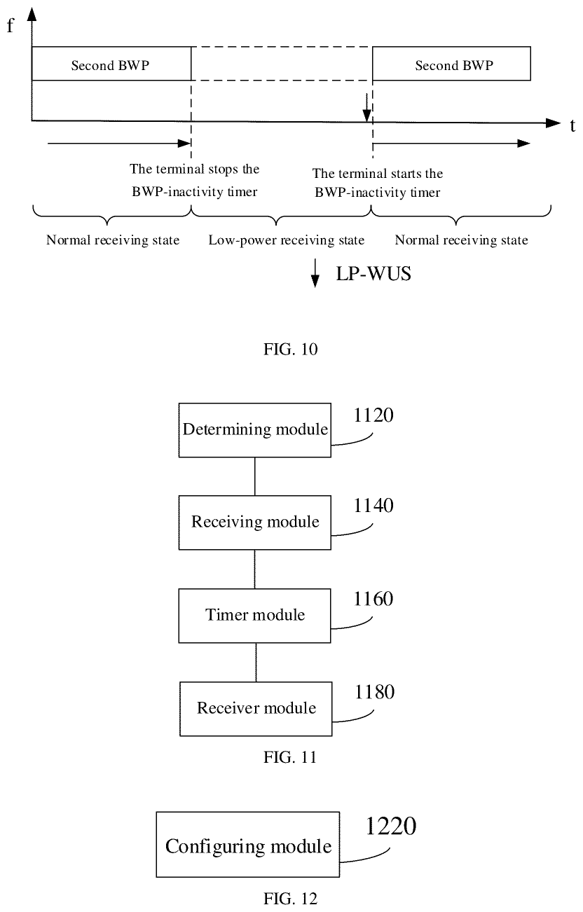

Taking the first receiving state being a low-power receiving state and the second receiving state being a normal receiving state as an example, FIG. 10 shows a schematic diagram of a method for switching BWPs according to some embodiments of the present disclosure.

Illustratively, for a terminal in an RRC connected state, the terminal stops or suspends the BWP-inactivity timer that is operating in response to switching from the normal receiving state to the low-power receiving state. In response to switching from the low-power receiving state to the normal receiving state, the terminal continues to operate on the original activated BWP while starting or resuming the operation of the BWP-inactivity timer.

The method for switching BWPs according to the embodiments of the present disclosure specifically includes the following processes.
(1) For a terminal in an RRC connected state, the terminal is in a normal receiving state.

For an activated serving cell i, a currently activated BWP of the terminal is a second BWP, and meanwhile, a BWP-inactivity timer corresponding to the second BWP is operating.

In response to switching from the normal receiving state to the low-power receiving state and the preset condition being satisfied, the terminal performs one of the following operations on the BWP-inactivity timer corresponding to the second BWP: a first operation, that is, stopping the operation of the BWP-inactivity timer; and a second operation, that is, suspending the BWP-inactivity timer that is operating.
(2) In a low-power receiving state, the terminal monitors an LP-WUS.

For example, the terminal monitors the LP-WUS using an LP-WUS receiver. At the moment, the LP-WUS receiver is in an operating state, and the primary receiver is in an off state or a deep sleep state.
(3) The terminal wakes up the primary receiver in response to receiving the LP-WUS.

Illustratively, for the activated serving cell i, the BWP activated by the terminal in the serving cell is the second BWP.

In response to the preset condition being satisfied, the terminal performs one of the following operations on the BWP-inactivity timer corresponding to the second BWP: a third operation, that is, starting the BWP-inactivity timer; and a fourth operation, that is, resuming the operation of the BWP-inactivity timer.

The third operation corresponds to the first operation, and the fourth operation corresponds to the second operation.

In some embodiments, the preset condition is as follows: The network device configures a default downlink BWP for the terminal, and the second BWP is neither the default downlink BWP nor a dormant BWP; or the network device does not configure the default downlink BWP for the terminal, and the second BWP is neither an initial downlink BWP nor the dormant BWP.

In summary, in the method for switching BWPs according to the embodiments of the present disclosure, in the case that the target BWP is the second BWP activated by the terminal prior to entering the first receiving state, the terminal determines the second BWP in the activated serving cell as the activated BWP in the serving cell, such that the terminal determines the activated BWP based on the originally used BWP without requiring the network device to reconfigure the activated BWP.

In some embodiments, the BWP-inactivity timer corresponding to the second BWP is in a running state before the terminal is in the first receiving state.

In some embodiments, during the different state switching of the terminal, in addition to determining an activated BWP, the terminal further performs different processing on the BWP-inactivity timer: firstly, the terminal stops the BWP-inactivity timer in response to switching from the second receiving state to the first receiving state, and the terminal starts the BWP-inactivity timer in response to switching from the first receiving state to the second receiving state; and secondly, the terminal suspends the BWP-inactivity timer in response to switching from the second receiving state to the first receiving state, and the terminal resumes the operation of the BWP-inactivity timer in response to switching from the first receiving state to the second receiving state.

The following are apparatus embodiments of the present disclosure. For details not described in the apparatus embodiments of the present disclosure, reference is made to the corresponding method embodiments described above, which are not described any further.

FIG. 11 shows a structural block diagram of an apparatus for switching BWPs according to some embodiments of the present disclosure.

The apparatus includes: a determining module 1120, configured to determine a target BWP in an activated serving cell as an activated BWP in the activated serving cell in response to a first receiving state being switched to a second receiving state.

The first receiving state and the second receiving state have different transmission parameters. The transmission parameter includes at least one of a receiver, a waveform, a modulation mode, an encoding mode, or a multiple access mode.

In some embodiments, the target BWP includes one of: a first BWP configured by the network device, an initial activated BWP, or a second BWP activated by the terminal prior to entering the first receiving state.

In some embodiments, the target BWP includes a first BWP, and the apparatus further includes a receiving module 1140 configured to receive a configuration parameter of a first BWP configured by a network device.

In some embodiments, the first BWP indicates the activated BWP of the terminal in the activated serving cell in the case that the terminal switches from the first receiving state to the second receiving state.

In some embodiments, the configuration parameter of the first BWP is configured over a system message or terminal-specific signaling.

In some embodiments, the terminal-specific signaling includes one of: an RRC signaling, a MAC-CE, a PDCCH, or an LPW.

In some embodiments, the target BWP includes a second BWP, and the apparatus further includes: a timer module 1160 configured to stop a BWP-inactivity timer corresponding to the second BWP in response to the second receiving state being switched to the first receiving state and a preset condition being satisfied; and a determining module 1120 configured to determine the second BWP in the activated serving cell as an activated BWP in the activated serving cell.

In some embodiments, the determining module 1120 is operable to determine, by the terminal, a second BWP corresponding to each activated serving cell as an activated BWP corresponding to the activated serving cell in response to the first receiving state being switched to the second receiving state; and a timer module 1160 configured to start, by the terminal, the BWP-inactivity timer in response to the preset condition being satisfied.

In some embodiments, the target BWP includes a second BWP. The timer module 1160 is operable to suspend a BWP-inactivity timer corresponding to the second BWP in response to the second receiving state being switched to the first receiving state and the preset condition being satisfied. The determining module 1120 is operable to determine the second BWP in the activated serving cell as the activated BWP in the activated serving cell.

In some embodiments, the determining module 1120 is operable to determine, by the terminal, a second BWP corresponding to each activated serving cell as an activated BWP corresponding to the activated serving cell in response to the first receiving state being switched to the second receiving state. The timer module 1160 is operable to resume, by the terminal, the operation of the BWP-inactivity timer in response to the preset condition being satisfied.

In some embodiments, the preset condition includes: the network device configures a default downlink BWP for the terminal, and the second BWP is neither the default downlink BWP nor a dormant BWP; or the network device does not configure the default downlink BWP for the terminal, and the second BWP is neither an initial downlink BWP nor the dormant BWP.

In some embodiments, the BWP-inactivity timer is in a running state before the terminal is in the first receiving state.

In some embodiments, the terminal is in a radio resource control (RRC) connected state.

In some embodiments, the apparatus further includes a receiver module 1180 configured to monitor, by the terminal, a wake-up signal by a first receiver in the case that the terminal is in the first receiving state; and wherein the first receiver of the terminal is in an operating state, a second receiver of the terminal is in an off state or a deep sleep state, the first receiver is used in the first receiving state, and the second receiver is used in the second receiving state.

In some embodiments, the receiver module 1180 is further configured to wake up, by the terminal, the second receiver in response to receiving the wake-up signal.

FIG. 12 shows a structural block diagram of an apparatus for switching BWPs according to some embodiments of the present disclosure.

The apparatus includes: a configuring module 1220, operable to configure a configuration parameter of a first BWP for a terminal; wherein the first BWP is an activated BWP in an activated serving cell determined by the terminal in response to switching from a first receiving state to a second receiving state, the first receiving state and the second receiving state have different transmission parameters, and the transmission parameter includes at least one of a receiver, a waveform, a modulation mode, an encoding mode, or a multiple access mode.

In some embodiments, the first BWP indicates the activated BWP of the terminal in the activated serving cell in the case that the terminal switches from the first receiving state to the second receiving state.

In some embodiments, the configuring module 1220 is operable to configure, by a network device, the configuration parameter of the first BWP for the terminal over a system message; or configure, by the network device, the configuration parameter of the first BWP for the terminal over terminal-specific signaling.

In some embodiments, the terminal-specific signaling includes one of: an RRC signaling, a MAC-CE, a PDCCH, or an LPW.

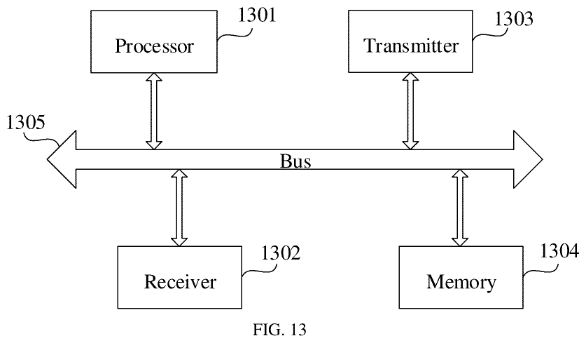

FIG. 13 shows a schematic structural diagram of a communication device (a terminal or a network device) according to some embodiments of the present disclosure, where the communication device includes: a processor 1301, a receiver 1302, a transmitter 1303, a memory 1304, and a bus 1305.

The processor 1301 includes one or more processing cores, and the processor 1301 runs various functional applications and performs information processing by running software programs and modules.

The receiver 1302 and the transmitter 1303 may be practiced as a communication assembly, which may be a communication chip.

The memory 1304 is connected to the processor 1301 over the bus 1305.

The memory 1304 is operable to store at least one instruction, and the processor 1301 is operable to execute the at least one instruction to perform the processes of the method for switching BWPs as described in the above method embodiments.

In addition, the memory 1304 may be implemented by any type of volatile or non-volatile storage devices or a combination thereof. The volatile or non-volatile storage device includes but is not limited to: a magnetic or optical disk, an electrically-erasable programmable read-only memory (EEPROM), an erasable programmable read-only memory (EPROM), a static random access memory (SRAM), a read-only memory (ROM), a magnetic memory, a flash memory, and a programmable read-only memory (PROM).

The embodiments of the present disclosure further provide a terminal. The terminal includes a processor configured to determine a target BWP in an activated serving cell as an activated BWP in the activated serving cell in response to switching from a first receiving state to a second receiving state; wherein the first receiving state and the second receiving state have different transmission parameters, the transmission parameter including at least one of a receiver, a waveform, a modulation mode, an encoding mode, or a multiple access mode.

The embodiments of the present disclosure further provide a network device. The network device includes a processor. The processor is operable to configure a configuration parameter of a first BWP for a terminal; wherein the first BWP is an activated BWP in an activated serving cell determined by the terminal in response to switching from a first receiving state to a second receiving state, the first receiving state and the second receiving state have different transmission parameters, and the transmission parameter includes at least one of a receiver, a waveform, a modulation mode, an encoding mode, or a multiple access mode.

The embodiments of the present disclosure further provide a non-transitory computer-readable storage medium. The computer-readable storage medium stores a computer program, and the computer programs, when run by a processor, cause the processor to perform the method for switching BWPs as described above.

The embodiments of the present disclosure further provide a chip. The chip includes a programmable logic circuit and/or program instructions. The chip, when running, is caused to perform the method for switching BWPs as described above.

The embodiments of the present disclosure further provide a computer program product or a computer program. The computer program product or the computer program includes computer instructions. The computer instructions are stored in a computer-readable storage medium, and when read from the computer-readable storage medium and executed by a processor, cause the processor to perform the method for switching BWPs as described above.

Described above are merely some embodiments of the present disclosure and are not intended to limit the present disclosure. Any modification, equivalent replacement, improvement, and the like, made within the spirit and principle of the present disclosure should fall within the protection scope of the present disclosure.

1. A method for switching bandwidth parts (BWPs), comprising:
determining, by a terminal, a target BWP in an activated serving cell as an activated BWP in the activated serving cell in response to switching from a first receiving state to a second receiving state,
wherein the first receiving state and the second receiving state have different transmission parameters, the transmission parameter comprising at least one of a receiver, a waveform, a modulation mode, an encoding mode, or a multiple access mode.

2. The method according to claim 1, wherein the target BWP comprises one of:
a first BWP configured by a network device;
an initial activated BWP; or
a second BWP activated by the terminal prior to entering the first receiving state.

3. The method according to claim 2, wherein the target BWP comprises the first BWP, and the method further comprises:
receiving, by the terminal, a configuration parameter of the first BWP configured by the network device.

4. The method according to claim 3, wherein the first BWP indicates the activated BWP of the terminal in the activated serving cell in response to the terminal switching from the first receiving state to the second receiving state.

5. The method according to claim 3, wherein the configuration parameter of the first BWP is configured over a system message or a terminal-specific signaling.

6. The method according to claim 5, wherein the terminal-specific signaling comprises one of:
a radio resource control (RRC) signaling;
a medium access control-control element (MAC-CE);
a physical downlink control channel (PDCCH); or
a low-power wake-up (LPW) signal.

7. The method according to claim 2, wherein
the target BWP comprises the second BWP, and the method further comprises:
stopping, by the terminal, a BWP-inactivity timer corresponding to the second BWP in response to switching from the second receiving state to the first receiving state and a preset condition being satisfied; and
determining, by the terminal, the target BWP in the activated serving cell as the activated BWP in the activated serving cell comprises:
determining, by the terminal, the second BWP in the activated serving cell as the activated BWP in the activated serving cell.

8. The method according to claim 7, wherein determining, by the terminal, the second BWP in the activated serving cell as the activated BWP in the activated serving cell comprises:
determining, by the terminal, a second BWP corresponding to each activated serving cell as an activated BWP corresponding to the activated serving cell in response to switching from the first receiving state to the second receiving state; and
starting, by the terminal, the BWP-inactivity timer in response to the preset condition being satisfied.

9. The method according to claim 2, wherein
the target BWP comprises the second BWP, and the method further comprises:
suspending, by the terminal, a BWP-inactivity timer corresponding to the second BWP in response to switching from the second receiving state to the first receiving state and a preset condition being satisfied; and
determining, by the terminal, the target BWP in the activated serving cell as the activated BWP in the activated serving cell comprises:
determining, by the terminal, the second BWP in the activated serving cell as the activated BWP in the activated serving cell.

10. The method according to claim 9, wherein determining, by the terminal, the second BWP in the activated serving cell as the activated BWP in the activated serving cell comprises:
determining, by the terminal, a second BWP corresponding to each activated serving cell as an activated BWP corresponding to the activated serving cell in response to switching from the first receiving state to the second receiving state; and
resuming, by the terminal, the operation of the BWP-inactivity timer in response to the preset condition being satisfied.

11. The method according to claim 8, wherein the preset condition comprises:
the network device configures a default downlink BWP for the terminal, and the second BWP is neither the default downlink BWP nor a dormant BWP; or
the network device does not configure the default downlink BWP for the terminal, and the second BWP is neither an initial downlink BWP nor the dormant BWP.

12. The method according to claim 7, wherein the BWP-inactivity timer is in a running state before the terminal is in the first receiving state.

13. The method according to claim 1, wherein the terminal is in a radio resource control (RRC) connected state.

14. The method according to claim 1, further comprising:
monitoring, by the terminal, a wake-up signal by a first receiver in a case that the terminal is in the first receiving state,
wherein the first receiver of the terminal is in an operating state, a second receiver of the terminal is in an off state or a deep sleep state, the first receiver is used in the first receiving state, and the second receiver is used in the second receiving state.

15. The method according to claim 14, further comprising:
waking up, by the terminal, the second receiver in response to receiving the wake-up signal.

16. A terminal, comprising: a processor;
wherein the processor is operable to determine a target BWP in an activated serving cell as an activated BWP in the activated serving cell in response to switching from a first receiving state to a second receiving state,
wherein the first receiving state and the second receiving state have different transmission parameters, the transmission parameters comprising at least one of a receiver, a waveform, a modulation mode, an encoding mode, or a multiple access mode.

17. The terminal according to claim 16, wherein the target BWP comprises one of:
a first BWP configured by a network device;
an initial activated BWP; or
a second BWP activated by the terminal prior to entering the first receiving state.

18. A network device, comprising: a processor;
wherein the processor is operable to configure a configuration parameter of a first BWP for a terminal;
wherein the first BWP is an activated BWP in an activated serving cell determined by the terminal in response to switching from a first receiving state to a second receiving state, wherein the first receiving state and the second receiving state have different transmission parameters, the transmission parameter comprising at least one of a receiver, a waveform, a modulation mode, an encoding mode, or a multiple access mode.

19. The network device according to claim 18, wherein the first BWP indicates the activated BWP of the terminal in the activated serving cell in response to the terminal switching from the first receiving state to the second receiving state.

20. The network device according to claim 18, wherein the processor is operable to:
configure the configuration parameter of the first BWP for the terminal over a system message; or
configure the configuration parameter of the first BWP for the terminal over a terminal-specific signaling,
wherein the terminal-specific signaling comprises one of:
a radio resource control (RRC) signaling;
a medium access control-control element (MAC-CE);
a physical downlink control channel (PDCCH); or
a low-power wake-up (LPW) signal.
